(19) United States
(12) Patent Application Publication
(10) Pub. No.: US 2026/0371410 A1
(43) Pub. Date: Nov. 19, 2026

(54) OPPORTUNISTIC NON-PRIMARY CHANNEL ACCESS

(71) Applicant: HEWLETT PACKARD ENTERPRISE DEVELOPMENT LP, Spring, TX (US)

(72) Inventors: Jianpo Han, Beijing (CN); Andre Beaudin, St. Laurent (CA); Mohd Shahnawaz Siraj, San Jose, CA (US); Omar El Ferkouss, St. Laurent (CA)

(21) Appl. No.: 19/212,149

(22) Filed: May 19, 2025

(51) Int. Cl. H04W 74/08; H04W 74/00

(52) U.S. Cl. CPC H04W 74/0875; H04W 74/002

(57) ABSTRACT

A networking device, such as an access point, may decide whether a client device supports non-primary channel access (NPCA). Based on determining that client device supports NPCA, the networking device may prioritize a secondary channel over a primary channel for communicating with the client device. The networking device may, for example, determine whether the secondary channel is available irrespective of an availability of the primary channel. The networking device may, responsive to determining that the secondary channel is available, communicate with the client device over the secondary channel such that the availability of the primary channel remains unchanged by the communication.

### BACKGROUND

A basic service set (BSS) refers to a set of devices that communicate with each other within a network. When devices of different BSSs are in close proximity, the coverage area of their BSSs may overlap. In the case of overlapping BSSs (OBSSs), devices in one BSS might be able to hear and interfere with transmissions from another BSS on the same channel.

### BRIEF DESCRIPTION OF THE DRAWINGS

Some implementations of the present disclosure are described with respect to the following figures.

FIG. 1 is a network configuration that includes a set of overlapping base service sets, according to some examples;

FIG. 2 is a flow diagram of a process for opportunistically communicating with an NPCA-capable client device over a secondary channel, according to some examples;

FIG. 3 is a schematic diagram illustrating opportunistic use of non-primary channel access, according to some examples;

FIG. 4A is a block diagram of a set of overlapping base service sets at timepoint t1, according to some examples;

FIG. 4B is a block diagram of the set of overlapping base service sets at timepoint t2, according to some examples;

FIG. 4C is a block diagram of the set of overlapping base service sets at timepoint t4, according to some examples;

FIG. 4D is a block diagram of the set of overlapping base service sets at timepoint t5, according to some examples;

FIG. 5 is a flow diagram of a process for opportunistically communicating with an NPCA-capable client device over a secondary channel, according to some examples;

FIG. 6 is a block diagram of a networking device capable of opportunistically communicating with an NPCA-capable client device over a secondary channel, according to some examples; and

FIG. 7 depicts a block diagram of an example computing system.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION

Non-primary channel access (NPCA) is a technique that may be employed in the technical standard IEEE 802.11bn (referred to interchangeably as Wi-Fi 8 or ultra-high reliability (UHR)) to improve channel access efficiency for OBSSs. With NPCA, when a primary channel is busy due to traffic from a first, overlapping BSS, a secondary channel may be used for communication between an access point (AP) and a client device (e.g., a station (STA)) of a second BSS. Thus, the primary channel and the secondary channel may simultaneously be used for separate communications (e.g., for communication by the first BSS and communication by the second BSS, respectively), which may reduce channel access delays for devices within the first BSS and/or the second BSS.

However, NPCA may not be supported by all devices in a network. For instance, while legacy devices (e.g., devices operating in accordance with a legacy communication standard) may support communication over the primary channel, these devices may not support switching to communication over the secondary channel. As a result, when the primary channel is already busy, a legacy device may wait for the primary channel to become free before communicating. In this regard, NPCA may fail to improve the channel access delay of legacy devices.

To address these issues, examples described herein relate to opportunistically (e.g., proactively) communicating with NPCA-capable client device(s) over the secondary channel, even when the primary channel is available, so that the primary channel is left available to legacy devices that do not support NPCA. In particular, examples relate to determining whether a client device supports NPCA. In cases where the client device supports NPCA, an access point may prioritize a secondary channel over a primary channel for communicating with the client device. Prioritizing the secondary channel may involve determining whether the secondary channel is available irrespective of an availability of the primary channel (e.g., regardless of whether the primary channel is available or is not available). Prioritizing the secondary channel may also involve communicating with the client device over the secondary channel such that the availability of the primary channel remains unchanged by the communication. In this regard, the communication may not occupy an otherwise available primary channel nor collide with an additional communication currently occupying an unavailable primary channel.

In Wi-Fi, channels having a bandwidth of 20 megahertz (MHz), 40 MHz, 80 MHz, 160 MHz, 320 MHz, or the like may be used for communications. As described herein, a primary channel may be a designated (e.g., dedicated) channel or set of sub-channels for communications such that the primary channel is a particular portion of the bandwidth available for communications. A secondary channel (e.g., a non-primary channel) may be the remaining, undesignated portion of the bandwidth available for communications. While examples described herein refer to a secondary channel, in some cases the term “secondary channel” may refer to multiple secondary channels.

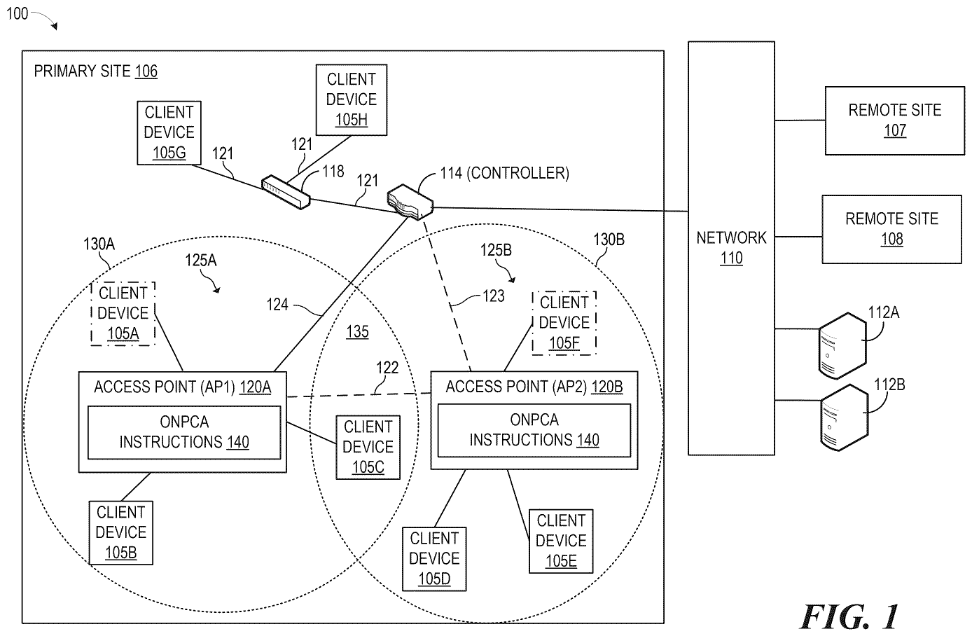

FIG. 1 illustrates an example of a network configuration 100 that includes a set of overlapping base service sets. Network configuration 100 may be implemented for an organization, such as a business, educational institution, governmental entity, healthcare facility or other organization. This diagram illustrates an example of a configuration implemented with an organization having multiple users (or at least multiple client devices 105) and possibly multiple physical or geographical sites 106, 107, 108. The network configuration 100 may include a primary site 106 in communication with a network 110. The network configuration 100 may also include one or more remote sites 107, 108, that are in communication with the network 110. Remote sites 107, 108 may include similar devices and/or components as those described with respect to primary site 106 which are not shown for ease of illustration.

The network 110 may be a public or private network, such as the Internet, or other communication network to allow connectivity among the various sites 106, 107, 108 as well as access to servers 112A-B. The network 110 may include third-party telecommunication lines, such as phone lines, broadcast coaxial cable, fiber optic cables, satellite communications, cellular communications, and the like. The network 110 may include any number of intermediate network devices, such as switches, routers, gateways, servers, and/or controllers, which are not directly part of the network configuration 100 but that facilitate communication between the various parts of the network configuration 100, and between the network configuration 100 and other network-connected entities.

The primary site 106 may include a primary network, which can be, for example, an office network, home network or other network installation. The primary site 106 network may be a private network, such as a network that may include security and access controls to restrict access to authorized users of the private network. Authorized users may include, for example, employees of a company at primary site 106, residents of a house, customers at a business, and so on.

The primary site 106 may include a variety of networking devices, such as access points, client devices, switches, controllers, routers, gateways, servers, and/or the like. In the illustrated example, the primary site 106 includes a controller 114 in communication with the network 110. The controller 114 may provide communication with the network 110 for the primary site 106, though it may not be the only point of communication with the network 110 for the primary site 106. A single controller 114 is illustrated, though the primary site may include multiple controllers and/or multiple communication points with network 110. In some embodiments, the controller 114 communicates with the network 110 through a router (not illustrated). In other embodiments, the controller 114 provides router functionality to the devices in the primary site 106.

A controller 114 may be operable to configure and manage network devices, such as at the primary site 106, and may also manage network devices at the remote sites 107, 108. The controller 114 may be operable to configure and/or manage networking devices, such as switches, routers, APs, and/or client devices, connected to a network. The controller 114 may itself be, or provide the functionality of, an AP.

The controller 114 may be in communication with one or more switches 118 and/or access points 110A-B (e.g., wireless access points). Switches 108 and access points 120A-B provide network connectivity to various client devices 105A-H. Using a connection to a switch 118 or access point 120A-B, a client device 105A-H may access network resources, including other devices on the (primary site 106) network and the network 110.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IOT) devices, and the like.

Within the primary site 106, a switch 118 is included as one example of a point of access to the network established in primary site 106 for wired client devices 105G-H. Client devices 105G-H may connect to the switch 118 and through the switch 118, may be able to access other devices within the network configuration 100. The client devices 105G-H may also be able to access the network 110, through the switch 118. In the illustrated example, the switch 118 communicates with the client devices 105G-H and the controller 114 over a wired connection 121, though this connection may also be wireless.

Access points 120A-B are included as another example of a point of access to the network established in primary site 106 for client devices 105A-F. Each of access points 120A-B may be a combination of hardware, software, and/or firmware that is configured to provide wireless network connectivity to wireless client devices 105A-F. In some examples, access points 120A-B can be managed and configured by the controller 114. In some cases, access points 120A-B may each communicate with the controller 114 over a respective connection, which may be a wireless or wired interface. In other cases, one access point 120 may communicate with the controller 114 directly and may relay information between the controller 114 and the other access point 120, as described further herein.

In some examples, networking devices within the primary site 106 may be mesh nodes configured in a mesh network. For instance, the first access point 120A and the second access point 120B may be mesh nodes (e.g., mesh access points). Examples of mesh nodes include a mesh portal and a mesh point. A mesh portal may be a gateway between a wireless network and a local area network (LAN), and in some examples, a mesh portal may use a wired interface to establish a link to a LAN. A mesh point may establish a wireless path to communicate traffic with the mesh portal and to access the LAN via the mesh portal. As an illustrative example, the first access point 120A may be a mesh portal, the second access point 120B may be a mesh point 120B, and the controller 114 may provide access to the network of the primary site 106 and/or the network 110. The second access point 120B may lack a direct interface to the controller 114 but may include a wireless interface 122 with the first access point 120A. In this regard, the dashed lines of interface 122 and interface 123 illustrate that these interfaces may optionally be included. In some cases, for example, the second access point 120B may have interface 123, which may be wired, to controller 114 and may lack the interface 122, which may be wireless, to the first access point 120A, and in other examples, the second access point 120B may lack the interface 123 to the controller 114 and may have the interface 122 to the first access point 120A. The first access point 120A may have a connection that is a wired interface 124 to the controller 114. As the mesh portal, the first access point 120A may relay information related to both the first access point 120A, as well as information received from the second access point 120B to the controller 114. The first access point 120A may further relay information from the controller 114 to the second access point 120B.

As further shown, the first access point 120A may be associated with (e.g., coordinate functions of) a first BSS 125A, and the second access point 120B may be associated with a second BSS 125B. In the illustrated example, the first BSS 125A includes the client devices 105A-C, while the second BSS 125B includes the client devices 105D-F. As used herein, the term first BSS 125A may be used to refer to the first access point 120A and the client devices 105A-C, and the term second BSS 125B may be used to refer to the second access point 120B and the client devices 105D-F.

Each of the access points 120A-B and the client devices 105A-F may have a respective radiofrequency (RF) coverage area (“coverage area”). Within the coverage area of a given device, the strength of signals from the device may be above a predefined value, which may contribute to these signals being received more reliably. In this regard, a client device positioned within the coverage area of an access point may hear (e.g., detect) transmissions from the access point, and an access point positioned within the coverage area of a client device may hear transmissions from the client device. In the illustrated example, coverage area 130A shows the coverage area of the first access point 120A, and coverage area 130B shows the coverage area of the second access point 120B. For ease of illustration, the coverage areas of the client devices 105A-F are not shown.

In some examples, the coverage area of a first device in one BSS may overlap with the coverage area of a second device in another BSS. Cases where the devices are so positioned and the first and second device use the same channel for communication may be referred to as overlapping BSSs. In such cases, signals from the second device may be heard and may cause interference at the first device. To illustrate a set of OBSSs, client device 105C is shown as being positioned within a region 135 of overlapping coverage between the coverage area 130A of the first access point 120A and 130B of the second access point 120B. In this position, if the first BSS 125A and the second BSS 125B use a given channel for communication, the client device 105C may detect transmissions from both the first access point 120A and the second access point 120B. Accordingly, the first BSS 125A may be referred to as overlapping the second BSS 125B, the second BSS 125B may be referred to as overlapping the first BSS 125A, or both. As described herein, each of the first BSS 125A and the second BSS 125B may be referred to as an OBSS, and the first BSS 125A and the second BSS 125B may be referred to collectively as a set of OBSSs.

With the overlap between the first BSS 125A and the second BSS 125B, the channel access efficiency of the client device 105C may be degraded in comparison with devices outside the region 135, as the client device 105C may wait longer to access the channel as the result of detecting additional traffic (from the second access point 120B). Further, in cases where the first access point 120A and the second access point 120B send a signal on the channel simultaneously, these signals may collide at the client device 105C. Such collisions may disrupt communication between the first access point 120A and the client device 105C, as the client device 105C may fail to successfully receive impacted signals from the first access point 120B. In cases where the access points 120A-B are mesh nodes, OBSSs may be especially disruptive because, with traffic between the mesh nodes, as well as traffic between the mesh nodes and their clients, there may be an increased likelihood of traffic that will cause collisions.

While a set of OBSSs is shown in FIG. 1 as a client device of one BSS falling within the coverage area of an access point of another BSS (“client device-access point coverage overlap”), BSSs may additionally or alternatively overlap as a result of a client device of one BSS falling within the coverage area of a client device of another BSS (“client device-client device coverage overlap”) or from an access point of one BSS falling within the coverage area of another access point of another BSS (“access point-access point coverage overlap”). The techniques described herein may be applicable to any combination of these forms of OBSSs (e.g., any combination of OBSSs resulting from client device-access point coverage overlap, client device-client device coverage overlap, and access point-access point coverage overlap).

With client devices that support NPCA (“NPCA-capable client devices”), an access point may, when the primary channel is determined to be unavailable, determine whether a secondary channel (a non-primary channel) is available. Switching to communicating over the secondary channel when the primary channel is unavailable may reduce the risk of collisions from OBSSs and may improve channel access efficiency. By communicating, using NPCA, with client device 105C over a secondary channel, for example, traffic from the first access point 120A may reach the client device 105C without colliding with traffic of the second access point 120B transmitted on the primary channel. However, NPCA may not be supported by all devices in a network, and thus, some devices may not be capable of switching to the secondary channel for communication.

To illustrate, NPCA-capable client devices (105B-E, as well as 105G-H) are shown in FIG. 1 with a solid border. Client devices that do not support NPCA (“legacy client devices”) are shown with a dash-dot border. As legacy client devices, client device 105A and client device 105F may support communication over the primary channel, but these devices may not support switching to communication over the secondary channel. As a result, when the primary channel is already busy, a client device 105A and client device 105F may wait for the primary channel to become free before communicating. In this regard, NPCA may fail to improve the channel access delay of legacy client devices, such as client device 105A and client device 105F.

Opportunistic NPCA (ONPCA) instructions 140, when executed, may reduce the risk of collision and improve channel access for both NPCA-capable client devices 105B-E and legacy client devices 105A, 105F. ONPCA instructions 140 may be machine-readable instructions, such as data and/or instructions that are executable by a physical processing resource, for example, a processor. In some examples, ONPCA instructions 140 may be stored in a machine-readable medium of the first access point 120A and the second access point 120B, as shown. However, examples are not limited thereto. In this regard, ONPCA instructions 140 may be stored in a machine-readable medium of any combination of networking device(s) within the network configuration 100. For instance, ONPCA instructions 140 may be stored in a machine-readable medium of the controller 114, the first access point 120A, the second access point 120B, a NPCA-capable client device 105B-E, and/or the like. In some examples, a networking device, such as the controller 114, may execute the ONPCA instructions 140 and, based on executing the instructions, may direct the first access point 120A and/or the second access point 120B to perform the operations described herein. In some examples, a networking device, such as the controller 114, may store the ONPCA instructions 140 in a machine-readable medium and may, based on an access point connecting to the networking device, transmit the ONPCA instructions 140 to the access point for execution at the access point.

ONPCA instructions 140 may include instructions to opportunistically (e.g., proactively) communicate with NPCA-capable client device(s) over the secondary channel, even when the primary channel is available, so that the primary channel is left available to legacy client devices that do not support NPCA. For instance, based on the ONPCA instructions 140, the first access point 120A may determine whether a client device in the first BSS 125A supports NPCA. With legacy client device 105A, which does not support NPCA, the first access point 120A may communicate over the primary channel. With NPCA-capable client devices, such as client device 105B-C, the first access point 120A may prioritize a secondary channel over a primary channel for communication. Prioritizing the secondary channel may involve determining whether the secondary channel is available irrespective of an availability of the primary channel (e.g., regardless of whether the primary channel is available or is not available). Prioritizing the secondary channel may also involve communicating with the NPCA-capable client devices 105B-C over the secondary channel such that the availability of the primary channel remains unchanged by the communication. In this regard, the communication with client devices 105B-C may not occupy an otherwise available primary channel nor collide with an additional communication, such as a communication from the second BSS 125B, currently occupying an unavailable primary channel.

In some examples, the second access point 120B may similarly, based on the ONPCA instructions 140, communicate with the legacy client device 105F on the primary channel and prioritize communicating with the NPCA-capable client devices 105D-E on the secondary channel. Accordingly, the first access point 120A may communicate with the NPCA-capable client device 105C over the secondary channel, and while this communication on the secondary channel is occurring, the second access point 120B may communicate with the legacy client device 105D on the primary channel without causing a collision at the NPCA-capable client device 105C. In this regard, even though the NPCA-capable client device 105C is within the coverage area 130A of the first access point 120A and the coverage area 130B of the second access point 120B (e.g., within the region 135), the NPCA-capable client device 105C may detect communication from the first access point 120A on the secondary channel without the communication of the second access point 120B on the primary channel interfering. Moreover, because the first access point 120A prioritized communicating with the NPCA-capable client device 105C over the secondary channel, even when the primary channel was free, the second access point 120B may use the primary channel to communicate with the legacy client device 105D without interference or channel access delay resulting from traffic of the first BSS 125A.

Further, in cases where the first BSS 125A includes a legacy client device positioned in the region 135, the ONPCA instructions 140 may reduce the likelihood of collisions and may improve channel access efficiency at the legacy client device. For instance, by prioritizing the secondary channel for communicating with the NPCA-capable client devices 105D-E, the second access point 120B may leave the primary channel available for communication between the first access point 120A and the legacy client device on the primary channel. Thus, while the second access point 120B is communicating with an NPCA-capable client device, the first access point 120A and a legacy client device within the region 135 may commence communication on the primary channel without the communication of the second access point 120B causing interference at the legacy client device.

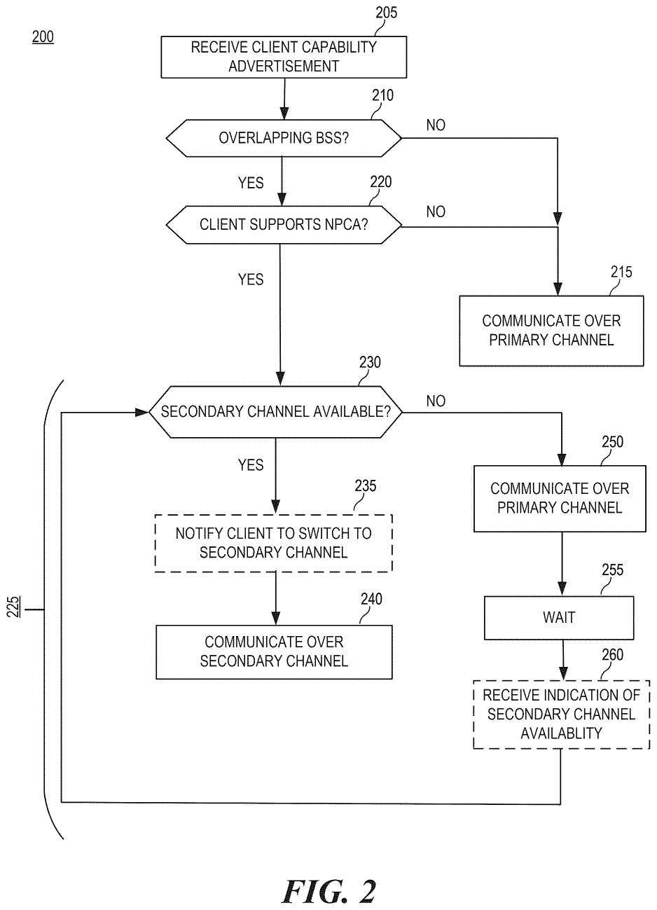

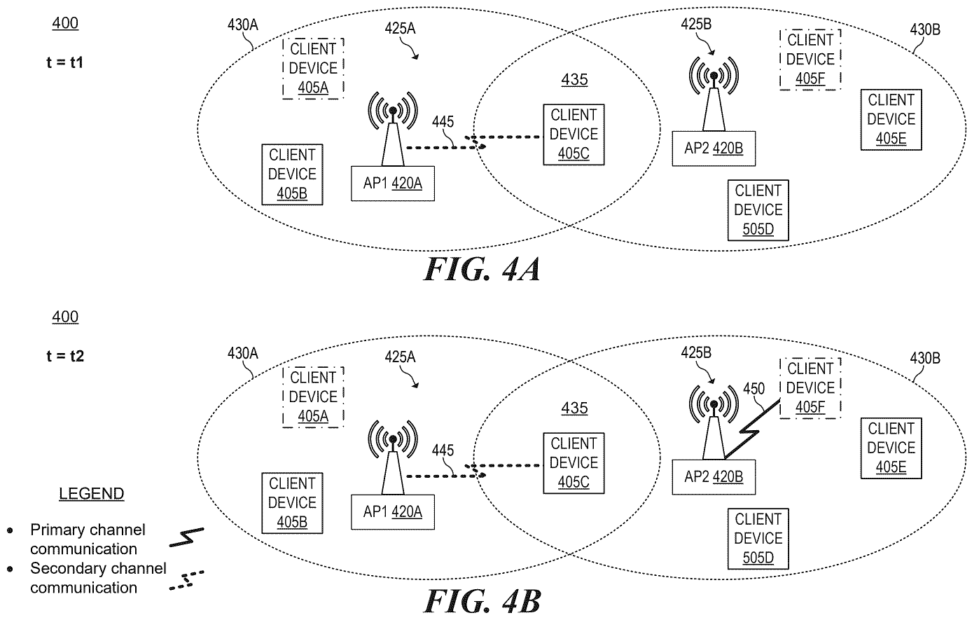

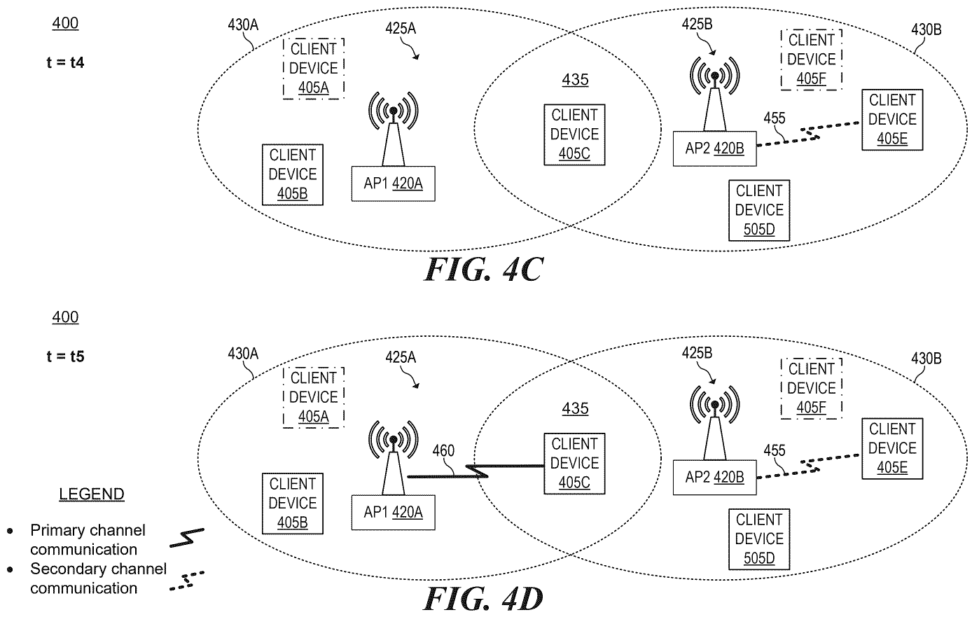

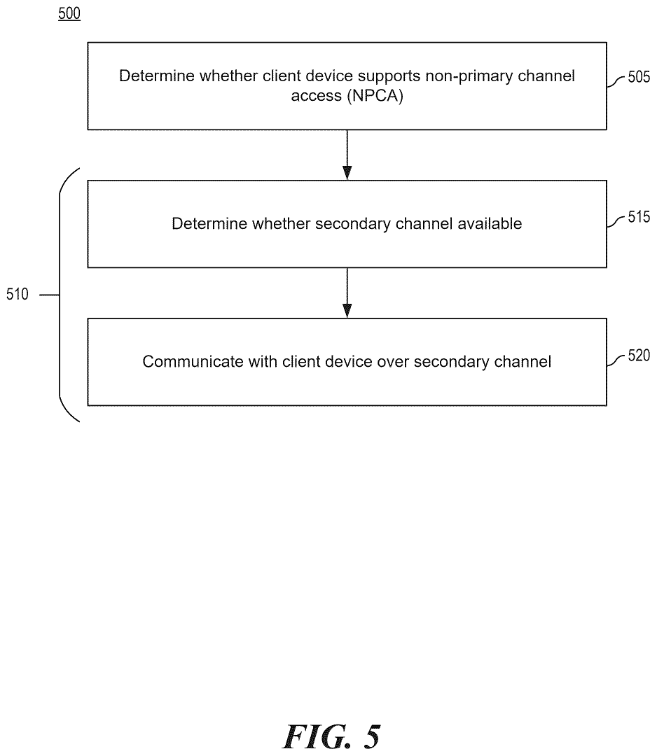

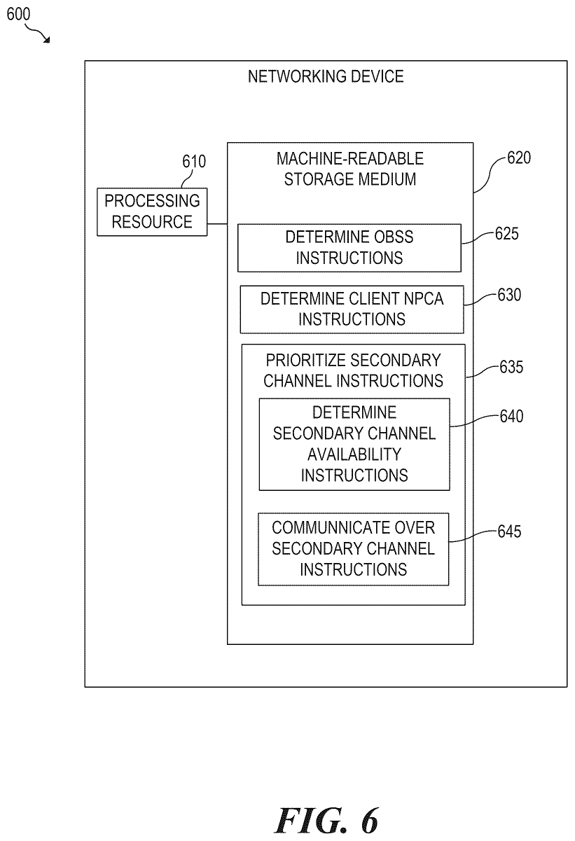

FIG. 2 is a flow diagram of a process 200 for opportunistically communicating with an NPCA-capable client device over a secondary channel (e.g., a non-primary channel), according to some examples. Process 200 may be implemented in the form of executable instructions, such as ONPCA instructions 140 (FIG. 1), stored on a machine-readable storage medium (e.g., machine-readable storage medium 620 of FIG. 6 or the like) and/or in the form of electronic circuitry. In some examples, operations of the process 200 may be performed by a networking device (e.g., networking device 500 of FIG. 5), which may be a computing device, by executing the instructions. While process 200 is described as being performed by an access point (e.g., first access point 120A or second access point 120B of FIG. 1, first access point 420A or second access point 420B of FIGS. 4A-D, or the like), examples are not limited thereto. Further, although FIG. 2 shows tasks performed in a given order, the tasks may be performed in a different order, some tasks may be omitted, and other tasks may be added.

In some examples, an access point may (at 205) receive an advertisement of a capability of a client device. In some examples, the client device may transmit the advertisement directly to the access point such that the access point receives the advertisement from the client device. The client device may, for example, transmit the advertisement to the access point during an association process with the access point, such as within a probe request of the association process. In some examples, the access point may receive the advertisement from another device, such as another access point or another client device, which may forward information regarding the client device to the access point.

In some examples, the advertisement may indicate that the client device supports NPCA (e.g., that the client device is an NPCA-capable client device). In other examples, the advertisement may indicate that the client device does not support NPCA (e.g., that the client device is a legacy client device). The advertisement may, for example, include a field that is set to a first value (e.g., state) for NPCA-capable client devices and is set to a different, second value for legacy client devices. Additionally or alternatively, the advertisement may include an optional field. In such cases, the inclusion of the field in the advertisement may indicate that the client device supports NPCA and the absence of the field in the advertisement may indicate that the client device does not support NPCA, or vice versa. In some examples, client devices that support NPCA may transmit the advertisement, while client devices that do not support NPCA may refrain from transmitting the advertisement.

In some examples, the access point may (at 210) determine whether an overlapping base service set is interfering with a base service set of the access point. An OBSS may interfere with the BSS of the access point when devices of the OBSS use the same channel, such as the same primary channel, as the devices of the BSS and when the transmissions of the OBSS may be heard (e.g., detected) by devices of the BSS.

Transmissions on the same channel from an OBSS may be heard by devices within the BSS when one or more devices of the BSS are positioned within the coverage area of one or more devices (e.g., client devices, access points, or the like) within the OBSS. Thus, when a client device and/or an access point of the BSS are positioned within the coverage area of a device (e.g., another client device and/or another access point) of the OBSS, the OBSS may interfere with the BSS. In this regard, an OBSS may interfere with the BSS as a result of any combination of client device-access point coverage overlap, client device-client device coverage overlap, and access point-access point coverage overlap.

In some examples, the access point may determine that an OBSS is interfering with the BSS of the access point based on detecting a message (e.g., a packet) from another BSS (the OBSS). The access point may detect the message by listening to a channel (e.g., the primary channel, the secondary channel, or both). The access point may further determine that the detected message is from another BSS based on information, such as a BSS identifier, included within the message (e.g., by decoding the message). For instance, the access point may determine that the detected message is from another BSS based on information included within a header of the message.

In some cases, a message from an OBSS may be detected at the access point but may not be detected at a client device within the same BSS. In this regard, while the access point may be positioned within the coverage area of the OBSS, the client device may be outside the coverage area and may thus fail to detect transmissions from the OBSS. Accordingly, in some examples, to coordinate behavior of the access point and the client device in cases of an OBSS, the access point may notify the client device of the OBSS. The access point may, for example, broadcast a neighbor report, which identifies the OBSS, in a beacon frame (e.g., in accordance with the IEEE 802.11k standard) to the client device. Based on the received beacon frame, the client device may determine that the OBSS was detected.

In other cases, a message from an OBSS may be detected at the client device within the BSS but may not be detected at the access point of the BSS. In this regard, while the client device may be positioned within the coverage area of the OBSS, the access point may be outside the coverage area and may thus fail to detect transmissions from the OBSS. Accordingly, in some examples, to coordinate behavior of the access point and the client device in cases of an OBSS, the client device may notify the access point of the OBSS. In some examples, the client device may notify the access point of the OBSS in response to detecting the OBSS. In other examples, the client device may notify the access point of the OBSS in response to receiving a request from the access point.

For instance, the access point may (in accordance with the IEEE 802.11k standard) request a scan report from the client device. In response to the request, the client device may transmit the scan report, which may identify the OBSS, to the access point. The scan report may, for example, include a list of devices neighboring the client device (e.g., neighbor devices), and inclusion of a device outside the BSS on the list may identify the OBSS. In some cases, the client device may generate the scan report (e.g., by performing a scan for neighbor devices) in response to receiving the request for the scan report from the access point. In some cases, the client device may, in response to receiving the request, transmit a scan report the client device previously generated to the access point. In some examples, the client device may notify the access point of the OBSS in response to detecting the OBSS (e.g., in response to detecting a message from the OBSS), regardless of whether the access point requested a scan report from the client device.

Thus, the access point may (at 210) determine whether an OBSS is interfering with the BSS of the access point based on detecting the OBSS itself (e.g., detecting a message from the OBSS) and/or based on a notification (e.g., a scan report) from the client device identifying the OBSS. Moreover, in some examples, regardless of whether an OBSS was initially detected at the access point or the client device, both the access point and the client device may be made aware of the OBSS.

In response to determining that there is no OBSS interfering with the BSS of the access point, the access point may (at 215) communicate over the primary channel. In this regard, in cases where transmissions from another BSS are not interfering with the transmissions within the BSS of the access point on a primary channel, the access point may communicate with a client device over the primary channel (e.g., without employing non-primary channel access).

In response to determining that an OBSS is interfering with the BSS of the access point, the access point may (at 220) determine whether the client device supports NPCA. In this regard, the access point may determine whether the client device is an NPCA-capable client device or a legacy client device. A client device that supports NPCA (e.g., an NPCA-capable client device) may be capable of using either the primary channel or a secondary channel to communicate with the access point. A client device that does not support NPCA (e.g., a legacy client device), on the other hand, may support communicating with the access point over the primary channel but may not support switching to communicating with the access point over the secondary channel.

The access point may determine whether the client device supports NPCA based on information received from the client device directly or indirectly (e.g., via another client device or access point). For instance, the access point may determine whether the client device supports NPCA based on the advertisement received at 205. As described herein, for example, the access point may determine whether the client device supports NPCA based on receipt of the advertisement and/or based on the value and/or inclusion of a field within the advertisement. For an NPCA-capable client device, the advertisement may indicate that the client device supports NPCA, and for a legacy client device, the advertisement may indicate that the client device does not support NPCA.

In response to determining that the client device does not support NPCA (e.g., in response to determining that the client device is a legacy client device), the access point may (at 215) communicate over the primary channel. In some examples, a client device that does not support NPCA may be incapable of switching to communicating over a secondary channel. Accordingly, the access point may maintain communications with such devices over the primary channel.

In response to determining that the client device does support NPCA (e.g., in response to determining that the client device is an NPCA-capable client device), the access point may (at 225) prioritize a secondary channel over a primary channel for communicating with the client device. As shown, prioritizing the secondary channel may involve operations of one or more of tasks 230-260.

For instance, prioritizing the secondary channel over the primary channel for communicating with the client device may involve determining (at 230) whether the secondary channel is available (e.g., idle). In particular, the access point may determine, irrespective of an availability of the primary channel, whether the secondary channel is available. In this regard, the access point may determine whether the secondary channel is available even when the primary channel is available (e.g., during a period when the primary channel is available). In some examples, the access point may determine whether the secondary channel is available by determining the availability of the secondary channel without determining the availability of the primary channel (e.g., by refraining from determining the availability of the primary channel). In some examples, the access point may determine the availability of the primary channel, and regardless of whether the primary channel is available or is not available, the access point may determine the availability of the secondary channel.

In some examples, the access point may determine whether the secondary channel is available using a clear channel assessment (CCA). In this regard, the access point may listen at the physical layer (e.g., perform physical carrier sense), to the secondary channel to determine whether the secondary channel is available. The access point may, for example, determine that the secondary channel is not available based on detecting a transmission on the secondary channel that satisfies a threshold, such as a signal detect (SD) threshold, energy detect (ED) threshold, or both. The access point may determine that the secondary channel is available based on failing to detect a transmission on the secondary channel that satisfies a threshold.

In response to determining that the secondary channel is available, the access point may (at 235) notify the client device to switch to the secondary channel. For instance, the access point may, over the primary channel, transmit a notification to the client device to switch to the secondary channel. The access point may transmit the notification by transmitting a frame (e.g., a beacon frame), for example.

In response to determining that the secondary channel is available, the access point may further (at 240) communicate with the client device over the secondary channel. In communicating with the client device over the secondary channel, the access point may transmit a message to the client device and/or may receive a message from the client device over the secondary channel.

As shown by the dashed border of task 235, task 235 may optionally be included in process 200. In this regard, in some examples, the client device may communicate over (e.g., switch to) the secondary channel without receiving a notification to switch from the access point. The client device may, for example, be configured to determine that the OBSS interferes with the BSS and to determine whether the secondary channel is available. The client device may further be configured to, responsive to determining that the OBSS interferes with the BSS and to determining that the secondary channel is available, communicate over the secondary channel (e.g., regardless of whether a notification to do so is received from the access point). In this regard, while operations of process 200 are described as being performed by the access point, operations may additionally or alternatively be performed at the client device. Moreover, in some cases, the client device and the access point may be configured to perform similar operations in response to similar conditions. For instance, each of the access point and the client device may be configured to communicate over the secondary channel responsive to determining that the OBSS interferes with the BSS, that the client device supports NPCA, and that the secondary channel is available.

In response to determining that the secondary channel is not available, the access point may (at 250) communicate with the client device over the primary channel. Communicating over the primary channel (at 215 and/or at 250) may involve determining whether the primary channel is available. The access point may determine whether the primary channel is available using a CCA, as similarly described with respect to the secondary channel. In cases where the primary channel is not available, the access point may wait for the primary channel to become available to communicate over the primary channel. In some cases, when the primary channel is not available, the access point may wait for a duration to elapse, may subsequently determine whether the primary channel is available or the secondary channel is available, and may communicate over an available channel.

In some examples, to prioritize (at 225) the secondary channel over the primary channel, the access point may determine whether the secondary channel has become available at a point after the secondary channel was determined to be unavailable (e.g., at 230). In this regard, responsive to determining (at 230) that the secondary channel is not available, the access point may communicate (at 250) with the client device over the primary channel for a duration, and subsequent to the duration, the access point may determine whether the secondary channel has become available.

In FIG. 2, the duration is illustrated as task 255 of process 200, where the access point may wait. In waiting, the access point may continue communicating with the client device over the primary channel. In some examples, waiting for the duration may involve waiting to receive (at 260) an indication of the availability of the secondary channel. The access point may receive the indication from the client device or another client device, for example. In particular, a client device may determine the availability of the secondary channel and based on the determination, may transmit the indication of the availability to the access point. In some examples, the client device may transmit the indication in response to determining that the secondary channel is available. In particular, the client device may transmit the indication to the access point over the primary channel. Accordingly, in communicating with the client device over the primary channel, the access point may receive the indication from the client device.

In some examples, the client device may determine the availability of the secondary channel using techniques described herein with reference to the access point. For instance, the client device may listen to the secondary channel (e.g., employ a clear channel assessment) to determine the availability of the secondary channel. In some examples, the client device may listen to the secondary channel in response to a request from the access point, such as a request communicated by the access point over the primary channel. In some examples, the client device may be configured to listen to the secondary channel after a preconfigured (e.g., predetermined) duration elapses, as similarly described herein with respect to the access point. In some cases, the start of the duration may be based on receipt of a communication from the access point at the client device, based on transmission of a communication from the client device to the access point, or the like.

As shown by the dashed border of task 260, task 260 may optionally be included in process 200. In this regard, in some examples, the access point may not receive an indication of secondary channel availability from another device. In such examples, the access point may (at 255) wait for a duration to elapse, and based on the duration elapsing, the access point may (at 230) determine whether the secondary channel has become available. The access point may, for example, check whether the secondary channel has become free after communicating with the client device over the primary channel for the duration.

The duration may be a preconfigured (e.g., predetermined) duration. The access point may, for example, check the availability of the secondary channel after communicating on the primary channel for a certain amount of time (e.g., 0.5 milliseconds (ms), 1 ms, 5 ms, 10 ms, or the like). In some examples, the duration may be a static duration, which may remain unchanged each time the tasks 250-255 are repeated. In other examples, the duration may be changed as the tasks 250-255 are repeated. For instance, the access point may (at 255) wait a first duration following a first instance of determining that the secondary channel is unavailable, and the access point may (at 255) wait a different, second duration following a second instance of determining that the secondary channel is unavailable (e.g., responsive to determining that the secondary channel remains unavailable following the first duration elapsing).

The access point may additionally or alternatively determine the duration based on information sensed on the secondary channel. For instance, in determining whether the secondary channel is free, the access point may listen to (e.g., sense) the secondary channel for transmissions, as described herein. Examples of the transmissions may include a request to send (RTS) message, a clear to send (CTS) message, data transmissions, or the like. In cases where the access point detects a transmission on the secondary channel, the transmission may include information, such as a duration field, related to an estimated time to transmit and/or remaining time to finish transmitting the transmission. This information may be included in a header and/or preamble of the detected transmission, for example. Using the information, the access point may update a network allocation vector (NAV) associated with the secondary channel, which the access point may use to estimate when the secondary channel will become available. The NAV may, for example, be a counter that the access point may set based on the duration so that the access point can check the availability of the secondary channel at a point when the secondary channel is expected to be available (e.g., when the NAV counter reaches a certain value, such as zero).

Subsequent to communicating with the client device over the primary channel for some duration, the access point may at (230) determine whether the secondary channel has become available. In cases where the access point received an indication of the availability of the secondary channel (e.g., at 260), the access point may determine whether the secondary channel has become available based on this indication. In other cases, the access point may determine whether the secondary channel has become available by listening to the secondary channel (e.g., performing a CCA), as described herein.

In some examples, to determine whether the secondary channel has become available, the access point may pause communicating with the client device over the primary channel. The access point may, for example, refrain from sending a transmission to the client device over the primary channel and may refrain from listening for a transmission from the client device on the primary channel as the access point listens to the secondary channel to determine its availability. In other examples, the access point may communicate with the client device over the primary channel while the access point determines whether the secondary channel has become available. For instance, the access point may listen for a transmission from the client device on the primary channel while listening to the secondary channel to determine its availability.

In cases where the secondary channel has become available, the access point may switch to communicating with the client device over the secondary channel (e.g., at 240). In cases where the secondary channel remains unavailable, the access point may continue (and/or resume) to communicate with the client device over the primary channel (e.g., at 250).

In some examples, determining whether the secondary channel is available (at 230) and/or communicating over the secondary channel (at 240) may involve performing one or more channel access operations. The channel access operations may include the clear channel assessment described herein. The channel access operations may further include a backoff. Performing the backoff may involve waiting for a time before determining whether the secondary channel is available (at 230) and/or before attempting to communicate over the secondary channel (at 240). Based on the secondary channel being available after the backoff (e.g., based on successfully performing the backoff), the access point may determine that the secondary channel is available and may communicate over the secondary channel. In some cases, the first access point may repeat the backoff (e.g., with a same or different time) or may communicate over the primary channel based on the secondary channel being unavailable after the backoff. For instance, the access point may attempt the backoff a certain number of times (e.g., 1 attempt, 3 attempts, 5 attempts, or the like) before determining that the secondary channel is unavailable.

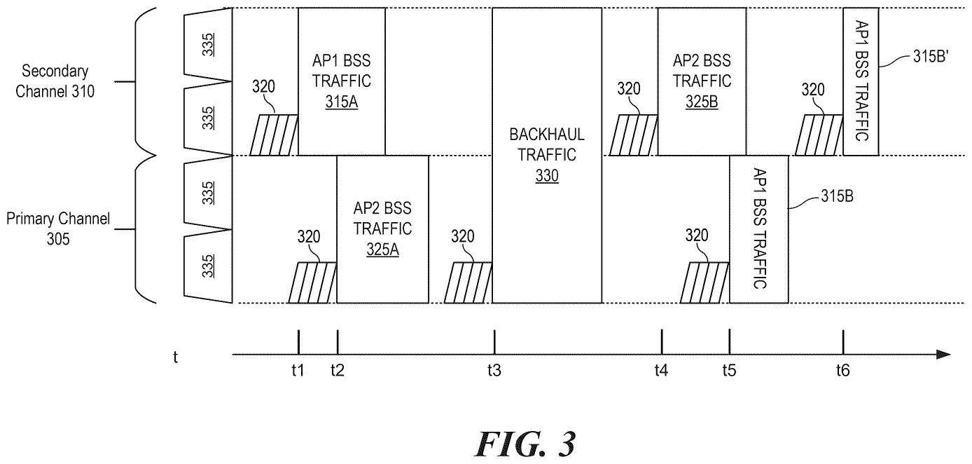

FIG. 3 is a schematic diagram illustrating opportunistic use of non-primary channel access, according to some examples. In particular, FIG. 3 illustrates use of a primary channel 305 and a secondary channel 310 over time (t) for communication by a set of overlapping BSSs in accordance with the techniques described herein (e.g., in accordance with process 200 of FIG. 2). The set of overlapping BSSs may include a first BSS of a first access point (AP1) overlapping with a second BSS of a different, second access point (AP2).

In the illustrated example, BSS traffic may refer to traffic between devices within a BSS, such as traffic between an access point and a client device within the same BSS. Accordingly, “AP1 BSS Traffic” may refer to traffic between the first access point and a client device in the first BSS, and “AP2 BSS Traffic” may refer to traffic between the second access point and a client device in the second BSS. Backhaul traffic may refer to traffic between access points in different BSSs. The illustrated “Backhaul Traffic,” for example, may refer to traffic between the first access point and the second access point.

As shown, at timepoint t1, the first access point may communicate AP1 BSS traffic 315A with a client device within the BSS of the first access point over the secondary channel 310. In communicating with the client device, the first access point may transmit data to the client device, may receive data from the client device, or both. In this regard, BSS traffic, such as AP1 BSS traffic 315A, may further refer to any combination of transmission(s) from an access point to a client device and transmission(s) from the client device to the access point. Further, in some cases, in communicating with the client device, the first access point may schedule traffic from the client device.

In some examples, the first access point may communicate with the client device over the secondary channel 310 responsive to determining that the second BSS is an overlapping BSS that interferes with the first BSS, as described with respect to task 210 of FIG. 2. The first access point may communicate with the client device over the secondary channel 310 further responsive to determining that the client device supports NPCA, as described with respect to task 220 of FIG. 2. Moreover, the first access point may communicate with the client device over the secondary channel 310 based on determining that the secondary channel 310 is available, as described with respect to task 230 of FIG. 2. Further, while not shown, in some cases, the first access point may notify the client device to switch to the secondary channel 310 to communicate with the client device over the secondary channel 310, as described with respect to task 235 of FIG. 2.

In some examples, the first access point may, at some point prior to timepoint t1, perform channel access operations 220 to gain access to the secondary channel. Channel access operations 320 may include performing a clear channel assessment, which the first access point may use to determine that the secondary channel 310 is free. The channel access operations 320 may further include performing a backoff on the secondary channel 310. In some examples, performing the backoff may involve waiting for a time before determining whether the secondary channel is available and/or before attempting to transmit on the secondary channel. The first access point may communicate over the secondary channel 310 based on the backoff being successfully completed. In this regard, based on the secondary channel being available after the backoff, the first access point may communicate over the secondary channel 310, and in some cases, the first access point may repeat the backoff (e.g., with a same or different time) or may communicate over the primary channel based on the secondary channel being unavailable. Further, as illustrated, in some examples, to communicate with the client device (e.g., to transmit and/or receive the AP1 BSS traffic 315A), the first access point may perform the channel access operations 320 solely on the secondary channel 310. In this regard, by prioritizing communicating with an NPCA-capable client device over the secondary channel 310, the first access point may determine whether the secondary channel 310 is available irrespective of the availability of the primary channel 305 (e.g., without having to first determine the availability of the primary channel), and may access the secondary channel 310 without having to access the primary channel 305. Thus, the first access point may perform the channel access operations 320 to communicate the AP1 BSS traffic 315A without having to perform a channel access operations 320, such as a backoff, on the primary channel 305.

Because the first access point may determine the availability of the secondary channel 310 irrespective of the availability of the primary channel 305, the first access point may communicate the AP1 BSS traffic 315A over the secondary channel 310 during a period (e.g., the period between timepoint t1 and timepoint t2) when the primary channel is free, as shown. More specifically, the first access point may initiate communicating the AP1 BSS traffic 315A over the secondary channel 310 during the period when the primary channel is free.

At timepoint t2, the second access point may communicate AP2 BSS traffic 325A with a client device of the second BSS. As illustrated, because the first access point prioritized communicating the AP1 BSS traffic 315A over the secondary channel 310 at timepoint t1, the primary channel 305 may be left available for other communications, such as the AP2 BSS traffic 325A. In this regard, by communicating the AP1 BSS traffic 315A over the secondary channel 310, AP1 BSS traffic 315A and AP2 BSS traffic 325A may be communicated concurrently at timepoint t2 over separate channels (e.g., the secondary channel 310 and the primary channel 305, respectively). Moreover, a collision between AP1 BSS traffic 315A and AP2 BSS traffic 325A at timepoint t2 may be avoided, including at a device within overlapping coverage of a device involved in AP1 BSS traffic 315A and a device involved in AP2 BSS traffic 325A.

In some examples, the AP2 BSS traffic 325A communicated at timepoint t2 may be an example of communication between the second access point and a legacy client device. In such cases, the legacy client device may not be capable of communicating (e.g., transmitting and/or receiving) the AP2 BSS traffic 325A over the secondary channel 310. Accordingly, because the first access point communicated the AP1 BSS traffic 315A over the secondary channel 310, the primary channel 305 may be available for the AP2 BSS traffic 325A, and the channel access delay for the AP2 BSS traffic 325A may be reduced. Further, in such cases, the second access point may communicate over the primary channel 305 responsive to determining that the client device does not support NPCA, as described with regard to task 220 and task 215 of FIG. 2.

In other examples, the AP2 BSS traffic 325A communicated at timepoint t2 may be an example of communication between the access point and an NPCA-capable client device. In such cases, the second access point may transmit the AP2 BSS traffic 325A over the primary channel 305 responsive to determining that the secondary channel 310 is not available (e.g., as described with respect to task 250 of FIG. 2).

As shown at timepoint t3, in some examples, the first access point may communicate backhaul traffic 330 with the second access point. In some examples, the first access point and/or the second access point may use the primary channel 305, the secondary channel 310, or both to communicate the backhaul traffic 330. As an illustrative example, in cases where the first access point and the second access point are mesh nodes, the backhaul traffic 330 may be traffic between a mesh point and a mesh portal or between two mesh points. In some examples, the backhaul traffic 330 may be traffic transmitted from a network (e.g., a LAN) to one of the access points, such as traffic transmitted from the network via the first access point to the second access point, or the backhaul traffic 330 may be traffic transmitted from one of the access points to the network, such as traffic transmitted from the second access point to the network via the first access point.

At timepoint t4, the second access point may communicate AP2 BSS traffic 325B over the secondary channel 310. In some examples, the second access point communicating the AP2 BSS traffic 325B over the secondary channel 310 at timepoint t4 may be similar to the first access point communicating the AP1 BSS traffic 315A over the secondary channel 310 at timepoint t1. In this regard, the second access point may, based on determining that the first BSS overlaps with the second BSS and that a client device supports NPCA, determine that the secondary channel 310 is free. Based on determining that the secondary channel 310 is free, the second access point may communicate the AP2 BSS traffic 325B with the NPCA-capable client device over the secondary channel 310.

At timepoint t5, the first access point may communicate AP1 BSS traffic 315B with a client device over the primary channel 305. In some examples, the AP1 BSS traffic 315B communicated at timepoint t5 may be an example of communication between the first access point and an NPCA-capable client device. Accordingly, the first access point may transmit the AP1 BSS traffic 315B over the primary channel 305 responsive to determining that the secondary channel 310 is not available due to the AP2 BSS traffic.

As described with respect to tasks 250-260 of FIG. 2, in some examples, the first access point may communicate over the primary channel for a duration, and subsequent to the duration, the first access point may determine whether the secondary channel 310 has become available. In cases where the secondary channel 310 has become available, the first access point may switch to communicating over the secondary channel 310. For instance, as illustrated at timepoint t6, the first access point may switch from communicating AP1 BSS traffic 315B over the primary channel 305 to communicating AP1 BSS traffic 315B′ over the secondary channel 310. In this regard, in some examples, the AP1 BSS traffic 315B communicated over the primary channel 305 may include an indication of the availability of the secondary channel 310, as described with respect to task 260 of FIG. 2. Additionally or alternatively, the first access point may switch to communicating over the secondary channel 310 based on estimating when the AP2 BSS traffic 325B will be completed.

As further shown, the primary channel 305 and the secondary channel 310 may each have a bandwidth, which may be divided into sub-channels 335. In some examples, the primary channel 305 and the secondary channel 310 may each have a bandwidth of 20 MHz, 40 MHz, 80 megahertz MHz, 160 MHz, 320 MHz, or the like. As an illustrative example, in cases where the bandwidth of each of the primary channel 305 and the secondary channel is 80 MHz, the primary channel 305 and the secondary channel is 80 MHz may each be divided into two sub-channels 335 having a bandwidth of 40 MHz. While the example shown in FIG. 3 is illustrated with two sub-channels 335 in the primary channel 305 and two sub-channels 335 in the secondary channel 310, the primary channel 305 and the secondary channel 310 may be divided into any number of sub-channels.

FIGS. 4A-4D illustrate a block diagram of a set of overlapping base service sets 400, according to examples. In particular, each of FIGS. 4A-4D show the set of OBSSs 400 at a particular point, corresponding to a timepoint shown in FIG. 2. For instance, FIG. 4A shows the set of OBSSs 400 at timepoint t1; FIG. 4B shows the set of OBSSs 400 at timepoint t2; FIG. 4C shows the set of OBSSs 400 at timepoint t4; and FIG. 4D shows the set of OBSSs 400 at timepoint t5. In FIGS. 4A-4D, NPCA-capable client devices (405B-E) are shown in with a solid border, and legacy client devices (405A, 405F), which do not support NPCA, are shown with a dash-dot border.

As shown in FIGS. 4A-4D, the set of OBSSs 400 may include a first BSS 425A and a second BSS 425B. As an illustrative example, the first BSS 425A may include a first access point 420A, which may have a coverage area 430A, and client devices 405A-C. The second BSS 425B may include a second access point 420B, which may have a coverage area 430B, and client devices 405D-F. As further shown, the coverage area 430A and the coverage area 430B overlap at the region 435, where the client device 405C is positioned. Thus, the first BSS 425A and the second BSS 425B are overlapping. While not shown, the first access point 420A and/or the second access point 420B may include instructions, such as ONPCA instructions, to perform operations described herein, such as those described with respect to process 200 (FIG. 2).

The first BSS 425A and the second BSS 425B of the set of OBSSs 400 may be an example of the set of OBSSs (e.g., BSS 125A and BSS 125B) described with reference to FIG. 1. Thus some components of the set of OBSSs 400 correspond to (e.g., are implementation examples of) components of the set of OBSSs already described above. Such corresponding components are referred to herein using the reference numbers having the same last two digits, such as 420 and 120. The set of OBSSs 400 and the components included therein are but one example of how a set of OBSSs and its components might be implemented, and thus descriptions and other details of set of OBSSs 400 do not limit the description of FIG. 1. Further, while a certain arrangement is shown, examples are not limited thereto. In this regard, a BSS may include any number of client devices, in any combination of NPCA-capable client devices and legacy client devices.

With reference to FIG. 4A, at timepoint t1, the first access point 420A may communicate over the secondary channel, as illustrated by the communication 445. In particular, the communication 445 may represent transmission(s) from the first access point 420A to the client device 405C (an NPCA-capable client device) over the secondary channel and/or transmissions(s) from the client device 405C to the first access point 420A over the secondary channel. As further shown, the first access point 420A may communicate over the secondary channel during a period when the primary channel is available. In some examples, the communication 445 may correspond to the AP1 BSS Traffic 315A shown in FIG. 3. In this regard, the first access point 420A may communicate with the client device 405C responsive to determining that the second BSS 425B overlaps with the first BSS 425A, that the client device 405C supports NPCA, and that the secondary channel is available irrespective of an availability of the primary channel. Further, as shown in FIG. 4A, by communicating over the secondary channel, the first access point 420A may leave the first channel available to other communications, such as communications by the second BSS 425B.

Referring to FIG. 4B, at timepoint t2, the second access point 420B may communicate over the primary channel, as illustrated by the communication 450. In particular, the communication 450 may represent transmission(s) from the second access point 420B to the client device 405F (a legacy client device) over the primary channel and/or transmissions(s) from the client device 405F to the second access point 420B over the primary channel. In some examples, the communication 450 may correspond to the AP2 BSS Traffic 325A shown in FIG. 3. In this regard, the second access point 420B may communicate with the client device 405F responsive to determining that the client device 405F does not support NPCA.

As shown in FIG. 4B, the first access point 420A may communicate with an NPCA capable client device (client device 405C) over the secondary channel while avoiding collision with communication 450 of the second BSS 425B. In this regard, even though the client device 405C, in its position in the region 435, may hear transmissions of devices within the second BSS 425B, the communication 450 may not interfere with the communication 445 between the client device 405C and the first access point 420A, as these communications are on separate channels. By using the secondary channel and the primary channel, respectively, the first access point 420A and the second access point 420B may thus concurrently communicate the communication 445 and the communication 450. Moreover, by prioritizing using the secondary channel (at timepoint t1), the primary channel remains available (at timepoint t2) for communication 450 with a legacy client device. In this regard, the communication 445 leaves the availability of the primary channel unchanged, allowing the scheduling of the communication 450 on the primary channel to be independent of the communication 445.

FIG. 4C illustrates the second access point 420B, at timepoint t4, communicating over the secondary channel during a period when the primary channel is available, as shown by the communication 455. In particular, the second access point 420B is shown as communicating with the client device 405E (an NPCA-capable client device) over the secondary channel. In some examples, the communication 455 may correspond to the AP2 BSS Traffic 325B shown in FIG. 3. In this regard, the second access point 420B may communicate with the client device 405E responsive to determining that the first BSS 425A overlaps with the second BSS 425B, that the client device 405E supports NPCA, and that the secondary channel is available.

As shown in FIG. 4D, at timepoint t5, the first access point 420A may communicate over the primary channel, as illustrated by the communication 460. In particular, the communication 460 may represent transmission(s) from the first access point 420A to the client device 405C over the primary channel and/or transmissions(s) from the client device 405C to the first access point 420A over the primary channel. In some examples, the communication 460 may correspond to the AP1 BSS Traffic 315B shown in FIG. 3. In this regard, the first access point 420A may communicate with the client device 405C responsive to determining that the second BSS 425B overlaps with the first BSS 425A, that the client device 405C supports NPCA, and that the secondary channel is not available (e.g., due to communication 455).

FIG. 5 is a flow diagram of a process 500 for opportunistically communicating with an NPCA-capable client device over a secondary channel (e.g., a non-primary channel), according to some examples. Process 500 may be implemented in the form of executable instructions, such as ONPCA instructions 140 (FIG. 1), stored on a machine-readable storage medium (e.g., machine-readable storage medium 620 of FIG. 6 or the like) and/or in the form of electronic circuitry. In some examples, operations of the process 500 may be performed by a networking device (e.g., a networking device of FIG. 1, a networking device (e.g., an access point) of FIGS. 4A-D, networking device 600 of FIG. 6, or the like), which may be a computing device, by executing the instructions. While process 500 is described as being performed by an access point (e.g., first access point 120A or second access point 120B of FIG. 1, first access point 420A or second access point 420B of FIGS. 4A-D, or the like), which may be a mesh node (e.g., a mesh access point), examples are not limited thereto. Examples of an NPCA-capable client may include client device 105B-D of FIG. 1, client device 405B-D of FIGS. 4A-D, or the like. Further, although FIG. 5 shows tasks performed in a given order, the tasks may be performed in a different order, some tasks may be omitted, and other tasks may be added.

The process 500 includes (at 505) determining, by a networking device, such as an access point, whether a client device supports non-primary channel access. In some examples, the process 500 may involve determining whether the client device supports NPCA based on a capability advertised by the client device. For instance, the access point may receive the capability advertised by the client device and may then determine whether the client device supports NPCA, as described with respect to tasks 205 and 220 of FIG. 2. In some examples, the process 500 involves, responsive to determining that a legacy client device does not support NPCA, communicating with the legacy client device over the primary channel. In this regard, the access point may refrain from communicating over the secondary channel with the legacy client device.

The process 500 includes (at 510) prioritizing a secondary channel over a primary channel for communicating with the client device. In some examples, the access point may prioritize the secondary channel for communicating with the client device based on determining that the client supports NPCA.

In some examples, the process 500 may involve prioritizing the secondary channel further based on determining an overlapping base service set interferes with a base service set of the access point. The access point may determine that the OBSS interferes with the BSS of the access point based on detecting the OBSS itself (e.g., detecting a message from the OBSS) and/or based on a notification (e.g., a scan report) from the client device identifying the OBSS, as described with respect to task 210 (FIG. 2).

Prioritizing the secondary channel may include (at 515) determining, irrespective of an availability of the primary channel, whether the secondary channel is available. Determining whether the secondary channel is available may involve listening to the secondary channel. For instance, the access point may perform a CCA on the secondary channel to determine whether the secondary channel is available.

Determining whether the secondary channel is available irrespective of the availability of the primary channel may involve determining whether the secondary channel is available regardless of whether the primary channel is available or is not available. In this regard, in some examples, the process 500 may involve determining whether the secondary channel is available during a period when the primary channel is available.

Prioritizing the secondary channel may further include (at 520) communicating with the client device over the secondary channel such that the availability of the primary channel remains unchanged by the communication. Communicating with the client device over the secondary channel may involve transmitting message(s) to the client device and/or receiving message(s) from the client device. In some examples, the access point may communicate with the client device over the secondary channel responsive to determining that the secondary channel is available.

Further, in keeping the availability of the primary channel unchanged, the communication may neither collide with another communication occupying the primary channel nor occupy an otherwise available primary channel. In this regard, in some examples, the process 500 may involve communicating with the client device over the secondary channel during the period when the primary channel is available, as illustrated and described with respect to AP1 BSS traffic 315A of FIG. 3. In such cases, the primary channel may remain available to a different communication, such as a communication associated with the overlapping BSS (e.g., a BSS different from the BSS of the access point).

In some examples, the process 500 may involve performing a backoff on the secondary channel. The process 500 may further involve communicating with the client device over the secondary channel further based on the backoff. In this regard, the access point may perform one or more channel access operations and may communicate with the client device over the secondary channel based on successful completion of these operations, as illustrated and described with respect to channel access operations 320 of FIG. 3.

In some examples, the process 500 may involve responsive to determining the secondary channel is not available, communicating with the client device over the primary channel. The access point may, for example, communicate with the client device over the primary channel for a duration. Based on the duration elapsing, the networking device may determine whether the secondary channel has become available. Based on determining that the secondary channel has become available, the access point may switch to communicating with the client device over the secondary channel. The access point may further notify the client device to switch to the secondary channel based on determining that the secondary channel has become available.

FIG. 6 is a block diagram of a networking device 600 capable of opportunistically communicating with an NPCA-capable client device over a secondary channel (e.g., a non-primary channel), according to some examples. The networking device 600 includes a processing resource 610 and a machine-readable storage medium 620 including instructions 625, 630, 635, 640, and 645 (hereinafter collectively referred to as instructions 625-645) for opportunistic NPCA. The networking device 600 may be an electronic device capable of communicating with other devices using wireless communication protocols, for example, Wi-Fi communication standards. In some examples, the networking device 600 may be a wireless networking device such as an access point, a controller, a radio router, a radio transceiver, a switch, a Wi-Fi hotspot device, a BSS device, an ESS device, a radio base station, a WLAN controller, a gateway device, a sever, and the like. In some examples, the networking device 600 may be a client device capable of communicating with a wireless networking device. In some examples, networking device may be an example of a networking device described herein (e.g., controller 114, switch 118, access point 120A or 120B, and/or client device 105 of FIG. 1; access point 420A or 420B, client device 405 of FIGS. 4A-D; or the like).

The determine OBSS instructions 625 may be executable to determine that an OBSS interferes with a BSS of the access point.

The determine client NPCA instructions 630 may be executable to determine whether a client device supports NPCA. In some examples, the machine-readable storage medium 620 may further include instructions executable to receive, from the client device, an advertisement of a capability of the client device. In some cases, for example, the advertisement may be received as part of an association process between the client device and the networking device. The instructions may be further executable to determine whether the client device supports NPCA based on the advertisement, as described with respect to tasks 205 and 220 of FIG. 2.

The prioritize secondary channel instructions 635 may be executable to prioritize a secondary channel over a primary channel for communicating with the client device. In some examples, the prioritize secondary channel instructions 635 may be prioritize the secondary channel based on determining that the OBSS interferes with the BSS and that client device supports NPCA. The networking device 600 may, for example, determine that the OBSS interferes with the BSS of the networking device 600 based on detecting the OBSS itself (e.g., detecting a message from the OBSS) and/or based on a notification (e.g., a scan report) from the client device identifying the OBSS, as described with respect to task 210 (FIG. 2). The prioritize secondary channel instructions 635 may include the determine secondary channel availability instructions 640 and the communicate over secondary channel instructions 645.

The determine secondary channel availability instructions 640 may be executable to determine, irrespective of an availability of the primary channel, whether the secondary channel is available. Determining whether the secondary channel is available may involve listening to the secondary channel. For instance, the networking device 600 may perform a CCA on the secondary channel to determine whether the secondary channel is available, as described with respect to task 230 of FIG. 2. In some examples, the machine-readable storage medium 620 may further include instructions executable to determine whether the secondary channel is available during a period when the primary channel is available.

The communicate over secondary channel instructions 645 may be executable to responsive to determining that the secondary channel is available, communicate with the client device over the secondary channel. For instance, as described with respect to task 240 of FIG. 2, the networking device 600 may transmit traffic to the client device over the secondary channel and/or may receive traffic from the client device over the secondary channel. The communicate over secondary channel instructions 645 may further be executable to communicate with the client device over the secondary channel such that the availability of the primary channel remains unchanged by the communication.

In some examples, the machine-readable storage medium 620 may further include instructions executable to communicate with the client device over the secondary channel during the period when the primary channel is available. In some examples, the machine-readable storage medium 620 may further include instructions executable to communicate with the client device over the secondary channel based on notifying the client device to communicate over the secondary channel, as described with respect to task 235 of FIG. 2.

In some examples, the machine-readable storage medium 620 may further include instructions executable to communicate, with an access point (different from the networking device), over the primary channel and the secondary channel concurrently. For instance, the networking device may execute such instructions to communicate backhaul traffic with the access point, as illustrated and described with respect to backhaul traffic 330 (FIG. 3). In some examples, the networking device and the access point may be mesh nodes, for example.

In some examples, the machine-readable storage medium 620 may further include instructions executable to, responsive to determining that the secondary channel is not available, communicate with the client device over the primary channel for a duration. The instructions may further be executable to switch to communicating with the client device over the secondary channel based on determining that, subsequent to the duration, the secondary channel has become available. In some examples, the instructions may be further executable to receive, from the client device and over the primary channel, an indication of an availability of the secondary channel. The instructions may be further executable to, based on the indication, determine that, subsequent to the duration, the secondary channel has become available, as described with respect to tasks 230-260 of FIG. 2.

Processing resource 610 can include a collection of hardware processors. A hardware processor can include a microprocessor, a core of a multi-core microprocessor, a microcontroller, a programmable integrated circuit, a programmable gate array, or another hardware processing circuit. Processing resource 610 may fetch, decode, and execute instructions 625-645 to opportunistically communicate with an NPCA-capable client device over a secondary channel. As an alternative or in addition to retrieving and executing instructions, processing resource 610 may include at least one integrated circuit (IC), other control logic, other electronic circuits, or combinations thereof that include a number of electronic components for performing the functionality of instructions 625-645.

As described in detail herein, machine-readable storage medium 620 may be encoded with a series of executable instructions, including instructions 625-645. Machine-readable storage medium 620 may be encoded with executable instructions to perform the operations of the process 200 described in FIG. 2, the process 500 described in FIG. 5, and/or any other operations performed by a networking device, without limiting the scope of the present disclosure.

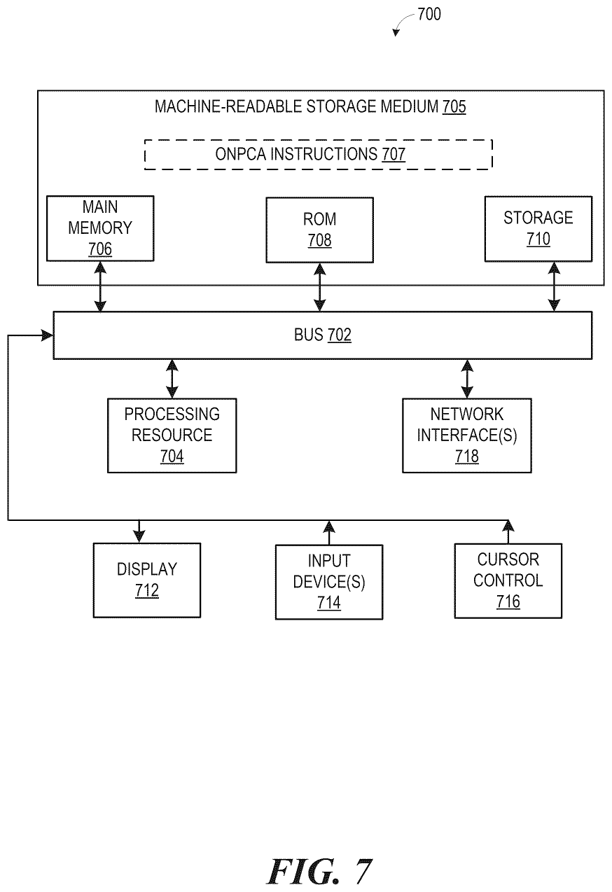

A storage medium (e.g., 620 in FIGS. 6, 705 in FIG. 7) in which machine-readable instructions are stored can include any or some combination of the following: a semiconductor memory device such as a dynamic or static random access memory (a DRAM or SRAM), an erasable and programmable read-only memory (EPROM), an electrically erasable and programmable read-only memory (EEPROM), or a flash memory; a magnetic disk such as a fixed, floppy and removable disk; another magnetic medium including tape; an optical medium such as a compact disk (CD) or a digital video disk (DVD); or another type of storage device. As such, the machine-readable storage medium 620 of FIGS. 6 and/or 705 of FIG. 7 can be non-transitory. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

FIG. 7 depicts a block diagram of an example computing system 700 in which various examples described herein may be implemented. In some examples, the computing system 700 may be configured to operate as a wireless networking device, (e.g., controller 114, switch 118, access point 120A or 120B, and/or client device 105 of FIG. 1; access point 420A or 420B, client device 405 of FIGS. 4A-D; networking device 600 of FIG. 6; or the like), capable of performing various operations described in one or more of the earlier drawings.

The computing system 700 may include a bus 702 or other communication mechanisms for communicating information, a hardware processor, also referred to as processing resource 704, and a machine-readable storage medium 705 coupled to the bus 702 for processing information. The processing resource 704 and the machine-readable storage medium 705 may be example representatives of the processing resource 610 and the machine-readable storage medium 620 of FIG. 6, certain details of which are not repeated herein for brevity.

In some examples, the machine-readable storage medium 705 may include a main memory 706, such as a RAM, cache, and/or other dynamic storage devices, coupled to the bus 702 for storing information and instructions to be executed by the processing resource 704. The main memory 706 may also be used for storing temporary variables or other intermediate information during the execution of instructions to be executed by the processing resource 704. Such instructions, when stored in storage media accessible to the processing resource 704, render the computing system 700 into a special-purpose machine that is customized to perform the operations specified in the instructions. The machine-readable storage medium 705 may further include a read-only memory (ROM) 708 or other static storage device coupled to the bus 702 for storing static information and instructions for the processing resource 704. Further, in the machine-readable storage medium 705, a storage device 710, such as a magnetic disk, optical disk, or USB thumb drive (Flash drive), etc., may be provided and coupled to the bus 702 for storing information and instructions.

Further, in some implementations, the computing system 700 may be coupled, via the bus 702, to a display 712, such as a liquid crystal display (LCD) (or touch-sensitive screen), for displaying information to a computer user. In some examples, an input device 714, including alphanumeric and other keys (physical or software-generated and displayed on a touch-sensitive screen), may be coupled to the bus 702 for communicating information and command selections to the processing resource 704. Also, in some examples, another type of user input device may be a cursor control 716, such as a mouse, a trackball, or cursor direction keys that may be connected to the bus 702. The cursor control 716 may communicate direction information and command selections to the processing resource 704 for controlling cursor movement on the display 712. In some other examples, the same direction information and command selections as cursor control may be implemented via receiving touches on a touchscreen without a cursor.

In some examples, the computing system 700 may include a user interface module to implement a GUI that may be stored in a mass storage device as executable software code that is executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

The computing system 700 also includes a network interface 718 coupled to bus 702. The network interface 718 provides a two-way data communication coupling to one or more network links that are connected to one or more local networks. For example, the network interface 718 may be an integrated services digital network (ISDN) card, cable modem, satellite modem, or a modem to provide a data communication connection to a corresponding type of telephone line. As another example, the network interface 718 may be a local area network (LAN) card or a wireless communication unit (e.g., Wi-Fi chip/module).

In some examples, the machine-readable storage medium 705 (e.g., one or more of the main memory 706, the ROM 708, or the storage device 710) stores ONPCA instructions 707 which when executed by the processing resource 704 may cause the processing resource 704 to execute one or more of the methods/operations described hereinabove. The ONPCA instructions 707 may be stored on any of the main memory 706, the ROM 708, or the storage device 710. In some examples, the ONPCA instructions 707 may be distributed across one or more of the main memory 706, the ROM 708, or the storage device 710. In some examples, when the computing system 700 is configured to operate as a networking device (e.g., controller 114, switch 118, access point 120A or 120B, and/or client device 105 of FIG. 1; access point 420A or 420B, client device 405 of FIGS. 4A-D; networking device 600 of FIG. 6; or the like), the ONPCA instructions 707 may include instructions which when executed by the processing resource 704 may cause the processing resource 704 to perform one or more of the methods described in FIGS. 2 and 5.

In the present disclosure, use of the term “a,” “an,” or “the” is intended to include the plural forms as well, unless the context clearly indicates otherwise. Also, the terms “includes,” “including,” “comprises,” “comprising,” “have,” or “having” when used in this disclosure specify the presence of the stated elements, but do not preclude the presence or addition of other elements.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method, comprising:
determining, by an access point, whether a client device supports non-primary channel access (NPCA); and
based on determining that client device supports NPCA, prioritizing, by the access point, a secondary channel over a primary channel for communicating with the client device by:
determining, by the access point and irrespective of an availability of the primary channel, whether the secondary channel is available; and
responsive to determining that the secondary channel is available, communicating, by the access point, with the client device over the secondary channel such that the availability of the primary channel remains unchanged by the communication.

2. The method of claim 1, further comprising:
determining, by the access point, whether the secondary channel is available during a period when the primary channel is available.

3. The method of claim 2, further comprising:
communicating, by the access point, with the client device over the secondary channel during the period when the primary channel is available.

4. The method of claim 1, further comprising:
prioritizing, by the access point, the secondary channel further based on determining an overlapping base service set interferes with a base service set of the access point.

5. The method of claim 1, further comprising:
responsive to determining the secondary channel is not available, communicating, by the access point, with the client device over the primary channel.

6. The method of claim 5, further comprising:
communicating, by the access point, with the client device over the primary channel for a duration;
based on the duration elapsing, determining, by the access point, whether the secondary channel has become available; and
based on determining that the secondary channel has become available, switching, by the access point, to communicating with the client device over the secondary channel.

7. The method of claim 6, further comprising:
notifying, by the access point and over the primary channel, the client device to switch to the secondary channel based on determining that the secondary channel has become available.

8. The method of claim 1, further comprising:
responsive to determining that a legacy client device does not support NPCA, communicating, by the access point, with the legacy client device over the primary channel.

9. The method of claim 1, further comprising:
determining, by the access point, whether the client device supports NPCA based on a capability advertised by the client device.

10. The method of claim 1, further comprising:
performing, by the access point, a backoff on the secondary channel; and
communicating, by the access point, with the client device over the secondary channel further based on the backoff.

11. The method of claim 1, wherein the access point comprises a mesh node.

12. A networking device comprising:
at least one processing resource; and
a non-transitory machine-readable storage medium comprising instructions executable by the at least one processing resource to:
determine that an overlapping base service set (OBSS) interferes with a base service set (BSS) of the networking device;
determine whether a client device supports non-primary channel access (NPCA); and
based on determining that the OBSS interferes with the BSS and that client device supports NPCA, prioritize a secondary channel over a primary channel for communicating with the client device by:
determining, irrespective of an availability of the primary channel, whether the secondary channel is available; and
responsive to determining that the secondary channel is available, communicating with the client device over the secondary channel such that the availability of the primary channel remains unchanged by the communication.

13. The networking device of claim 12, wherein the instructions are further executable to:
communicate with the client device over the secondary channel further based on notifying the client device to communicate over the secondary channel.

14. The networking device of claim 12, wherein the instructions are further executable to:
communicate with an access point over the primary channel and the secondary channel concurrently.

15. The networking device of claim 12, wherein the instructions are further executable to:
responsive to determining that the secondary channel is not available, communicate with the client device over the primary channel for a duration; and
based on determining that, subsequent to the duration, the secondary channel has become available, switch to communicating with the client device over the secondary channel.

16. The networking device of claim 15, wherein the instructions are further executable to:
receive, from the client device and over the primary channel, an indication of an availability of the secondary channel; and
based on the indication, determine that, subsequent to the duration, the secondary channel has become available.

17. The networking device of claim 12, wherein the instructions are further executable to:
determine whether the secondary channel is available during a period when the primary channel is available.

18. A non-transitory machine-readable storage medium comprising instructions executable by at least one processing resource of a networking device to:
determine that an overlapping base service set (OBSS) interferes with a base service set (BSS) of the networking device;
determine whether a client device supports non-primary channel access (NPCA); and
based on determining that the OBSS interferes with the BSS and that client device supports NPCA, prioritize a secondary channel over a primary channel for communicating with the client device by:
determining, during a period when the primary channel is available, whether the secondary channel is available; and
responsive to determining that the secondary channel is available, communicating with the client device over the secondary channel such that the availability of the primary channel remains unchanged by the communication.

19. The non-transitory machine-readable storage medium of claim 18, wherein the instructions are further executable to:
communicate with the client device over the secondary channel during the period when the primary channel is available.

20. The non-transitory machine-readable storage medium of claim 18, wherein the instructions are further executable to:
receive, from the client device, an advertisement of a capability of the client device; and
determine whether the client device supports NPCA based on the advertisement.
